(19) United States
(12) Patent Application Publication
(10) Pub. No.: US 2005/0283631 A1
(43) Pub. Date: Dec. 22, 2005

(54) System and method for performing power sequencing

(75) Inventor: Hyoung-su Kim, Gunpo-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 10/993,447

(22) Filed: Nov. 22, 2004

(30) Foreign Application Priority Data
Jun. 22, 2004 (KR) 10-2004-0046616

(51) Int. Cl. G06F 1/26

(52) U.S. Cl. 713/330

(57) ABSTRACT

Disclosed is a system and method for performing power sequencing. The system includes a main power supply unit for receiving a power from an external power source, a power sequencing drive unit for receiving an output voltage of the main power supply and outputting a preset first voltage, a power control unit for receiving the first voltage and outputting at least one different device drive voltage, and a device for receiving the first voltage and the device drive voltage and operating by the received voltages. The application of the first voltage and the device drive voltage can be selectively sequenced.

### CROSS-REFERENCE TO RELATED APPLICATION

This application claims the benefit under 35 U.S.C. § 119(a) to Korean Patent Application No. 10-2004-0046616, filed on Jun. 22, 2004 in the Korean Intellectual Property Office, the entire content disclosure of which is incorporated herein in its entirety by reference.

### BACKGROUND OF THE INVENTION

1. Field of the Invention

The present invention relates generally to the power sequencing, and more particularly to a system and method for supplying stable power to devices that require a power sequence.

2. Description of the Related Art

Generally, most systems are constructed to receive a specified power for their operation. In some cases, a single source power signal, which is supplied to a system, is divided into several kinds of power signals, and the divided power signals are provided to various kinds of devices that constitute the system. This is because power signals having different power levels are required for the respective devices. Power signal and power signals shall hereinafter be referred to as power and powers, respectively. FIG. 1 shows a conventional system 100 for supplying powers to various devices that constitute the system 100.

If it is assumed that the system 100 comprises a main power supply unit 110 and four devices 120, 130, 140 and 150, the respective devices 120, 130, 140 and 150 receive operating powers having different levels from the main power supply unit 110. This function of receiving a single external power supply as an input and outputting powers having various levels can be implemented by a Switching Mode Power Supply (SMPS).

Meanwhile, a device_D 150, which is, for example, an integrated circuit (IC) chip set such as a Central Processing Unit (CPU), may require powers having various levels rather than a single power. In this case, the device_D 150 receives a power D from the main power supply unit 110 as its main power and other necessary powers from a power control unit 160. The power control unit 160, as shown in FIG. 1, may comprise a plurality of regulator ICs Reg_{—}1, Reg_{—}2 and Reg_{—}3.

Meanwhile, ICs, which require powers having different levels such as the device_D 150, have a specified power sequence for the normal operation of the chips, in addition to a protection circuit for internally preventing an Electrostatic Discharge (ESD). In this case, the power sequence means the order or rule of power supply for a normal and stable operation of a device that operates with at least two powers having different levels without malfunctioning. If the powers are not supplied to match such a power sequence, the ICs may perform an unexpected operation, resulting in deterioration of product reliability.

For example, it is assumed that in the event that a power D is supplied to the device_D 150 by the conventional construction as illustrated in FIG. 1, levels of the power D, that is, power D-1, power D-2 and power D-3, are 3.3V, 2.5V, 1.8V and 1.5V, respectively. FIG. 2 is a graph showing time periods required for applying the powers to these device_D 150.

Specifically, the regulator ICs operate in the order of their operating voltage during a rising time when the power D is applied to the device_D 150 to supply the powers to the device_D 150. Accordingly, the power D-3 is first applied to the device_D 150, and then the power D-2, power D-1 and power D are applied to the device_D 150 in order.

In this case, if a power sequence for most rapidly applying the power D to the device_D 150 is required in order for the device_D 150 to perform a normal operation, the device_D 150 may not perform a normal operation due to the power sequence as shown in FIG. 2, and this may cause an unexpected result.

Accordingly, if the device, which operates with powers having different levels, requires a specified power sequence for performing a stable operation, it is necessary to design a circuit for supplying a stable power so as to satisfy the power sequence.

### SUMMARY OF THE INVENTION

Accordingly, the present invention has been made to solve the above-mentioned problems occurring in the prior art, and an object of the present invention is to provide a method for supplying a power according to a desired power sequence by shortening a rising time of the power supplied to a device that requires a power sequence condition and adjusting a time for the power supply to the device.

Additional advantages, objects, and features of the invention will be set forth in the description which follows and will be apparent to those having ordinary skill in the art.

In order to accomplish these objects, there is provided a system for performing a power sequencing, according to the present invention, comprising a main power supply unit for receiving a power from an external power source; a power sequencing drive unit for receiving an output voltage of the main power supply and outputting a first preset voltage; a power control unit for receiving the first voltage and outputting at least one different device drive voltage; and a device for receiving the first voltage and the device drive voltage and operating by the received voltages.

In another aspect of the present invention, there is provided a method for performing a power sequencing, according to the present invention, comprising the steps of (a) receiving a power from an external power source; (b) converting the power into a first voltage for operating devices that constitute a system; (c) converting the first voltage into at least one device drive voltage; and (d) outputting the first voltage and the device drive voltage to the devices.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram illustrating a conventional construction for supplying powers to devices;

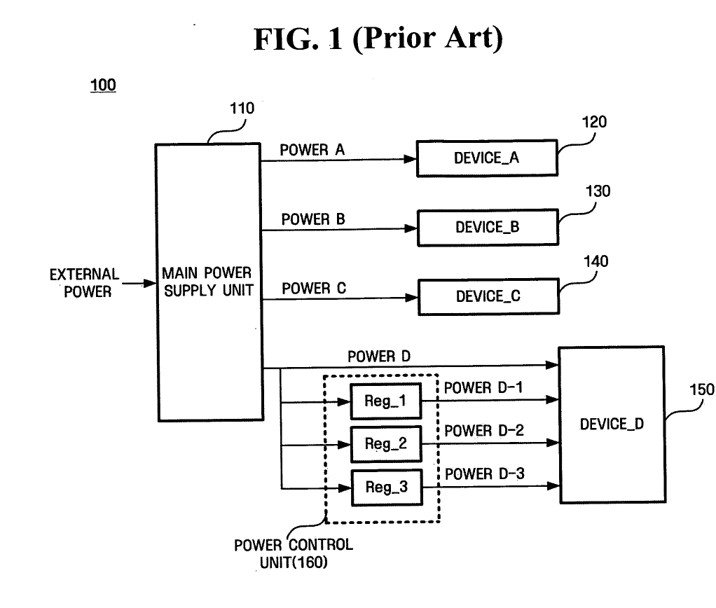

FIG. 2 is a graph illustrating time periods required for applying powers to the device according to the conventional construction of FIG. 1;

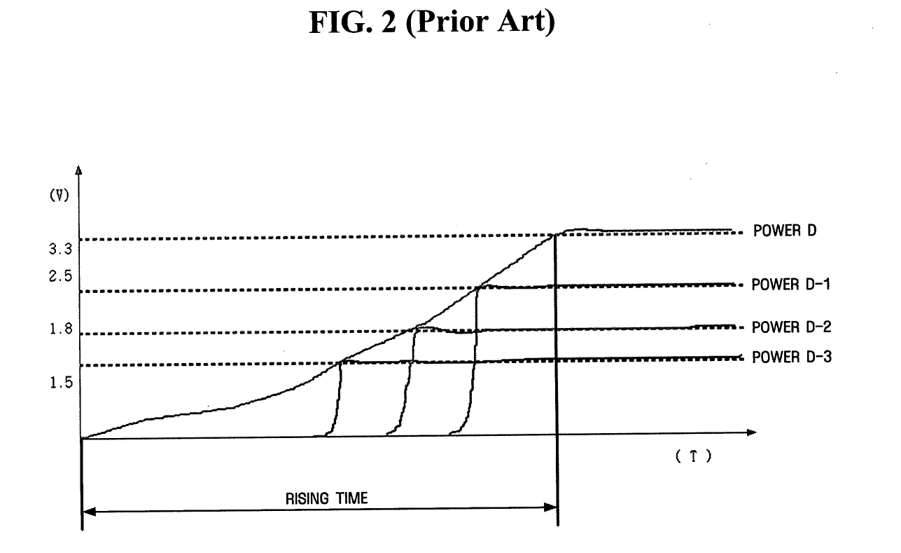

FIG. 3 is a block diagram illustrating the construction of a system for performing a power sequencing according to an embodiment of the present invention;

FIG. 4 is a graph illustrating time periods required for applying powers to the device of FIG. 3 according to an embodiment of the present invention;

FIG. 5 is a block diagram illustrating the construction of a system for performing a power sequencing according to another embodiment of the present invention;

FIG. 6 is a graph illustrating time periods required for applying powers to the device of FIG. 5 according to another embodiment of the present invention;

FIG. 7 is a block diagram illustrating the construction of a system for performing a power sequencing according to still another embodiment of the present invention;

FIG. 8 is a graph illustrating time periods required for applying powers to the device of FIG. 7 according to still another embodiment of the present invention; and

FIG. 9 is a flowchart illustrating a method for performing a power sequencing according to an embodiment of the present invention.

### DETAILED DESCRIPTION OF THE PREFERRED EMBODIMENTS

Hereinafter, preferred embodiments of the present invention will be described with reference to the accompanying drawings. The matters defined in the description, such as detailed construction and elements, are nothing but specific details provided to assist in a comprehensive understanding of the invention. Thus, it will be apparent that the present invention can be carried out without such limitations. In the following description of the present invention, the same drawing reference numerals are used for the same elements among/across various figures.

The present invention is described hereinafter with reference to flowchart illustrations of methods according to embodiments of the invention. It will be understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatuses to produce a machine, such that the instructions, which execute via the processor of the computer or other programmable data processing apparatuses, create means for implementing the functions specified in the flowchart block or blocks.

These computer program instructions may also be stored in a computer usable or computer-readable memory that can direct a computer or other programmable data processing apparatuses to function in a particular manner, such that the instructions stored in the computer usable or computer-readable memory produce an article of manufacture including instruction means that implement the function specified in the flowchart block or blocks.

The computer program instructions may also be downloaded into a computer or other programmable data processing apparatuses, causing a series of operational steps to be performed on the computer or other programmable apparatuses to produce a computer implemented process such that the instructions that execute on the computer or other programmable apparatuses provide steps for implementing the functions specified in the flowchart block or blocks.

And each block of the flowchart illustrations may represent a module, segment, or portion of code, which comprises one or more executable instructions for implementing the specified logical function(s). It should also be noted that in some alternative implementations, the functions noted in the blocks may occur out of order. For example, two blocks shown in succession may in fact be executed almost concurrently or the blocks may sometimes be executed in the reverse order, depending upon the functionality involved.

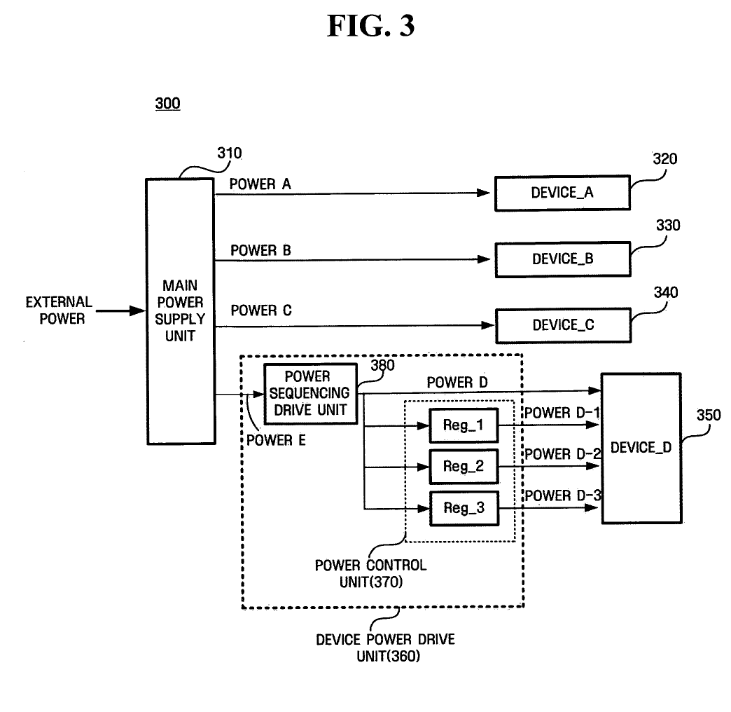

FIG. 3 is a block diagram illustrating the construction of a system 300 for performing a power sequencing according to an embodiment of the present invention.

Referring to FIG. 3, the system 300 comprises a main power supply unit 310, a plurality of devices 320, 330, 340 and 350, and a device power drive unit 360.

The main power supply unit 310 receives a single power from an external power source, and outputs powers (e.g., powers A, B, C and E) having different levels. The devices 320, 330, 340 and 350 receive the respective powers from the main power supply unit 310, and operate.

The device power drive unit 360 provides a power sequence for operating the devices that require powers having different levels using the power (e.g., power E) from the main power supply unit 310. In this case, the device power drive unit 360 comprises a power control unit 370 and a power sequencing drive unit 380. The power control unit 370 provides other powers except for the main power to the device. The power sequencing drive unit 380 receives power (e.g., power E) from the main power supply unit 310, supplies the main power to the device as indicated at power D, and supplies input powers to the power control unit 370. Meanwhile, the device 350 includes a physical hardware appliance or hardware element for performing a specified function, an IC chip set, etc.

As shown in FIG. 3, the device_D 350, which requires powers having different levels, does not receive the power directly from the main power supply unit 310, but rather receives power from the device power drive unit 360 that performs the power sequence. Accordingly, the circuit construction of the device power drive unit 360 can be designed to satisfy the power sequence for the normal operation of the device_D 350.

If an external power for operating the system is applied to the system 300, the main power supply unit 310 supplies power to a device_A 320, a device_B 330 and a device_C 340. For example, the main power supply unit 310 supplies a power A, power B and power C directly to the devices 320, 330 and 340, respectively.

Meanwhile, it is assumed that the device_D 350, which operates by four powers having different levels (in this case, it is assumed that the order of their power level is determined as the application of power D before power D-1, which is applied before power D-2, which in turn is applied before power D-3), has a power sequence in which the power D having the largest level is applied to the device_D 350 earlier than other powers (i.e., power D-1, power D-2 and power D-3) or at least simultaneously with other powers.

Accordingly, the power sequencing drive unit 380 in the device power drive unit 360 receives a power E from the main power supply unit 310, but does not supply any power to the device_D 350 until the power sequencing drive unit 380 can generate an output voltage of a specified level. If the power sequencing drive unit 380 reaches a state that it can generate the output voltage of the specified level, it supplies the power D to the device_D 350 as the main power. Then, the power sequencing drive unit 380 transfers its output voltage to the power control unit 370 in order to supply other powers (i.e., power D-1, power D-2 and power D-3) to the device_D 350. Preferably, the power sequencing drive unit 380 may be implemented using regulator ICs or step-down regulator ICs. The step-down regulator IC is an IC that can obtain desired output voltages by receiving a voltage of a specified range.

The power control unit 370, in order to convert the voltage received from the power sequencing drive unit 380 into the power D-1, power D-2 and power D-3, comprises the corresponding number of converters. Preferably, the converters may each be implemented using a regulator IC.

Accordingly, in consideration of the time required for converting the voltage through the power control unit 370, the power D may be first applied to the device_D 350, and then other powers (i.e., power D-1, power D-2 and power D-3) may be applied to the device_D almost simultaneously. Consequently, since the power D is not applied to the device_D 350 later than other powers (i.e., power D-1, power D-2 and power D-3), the device_D 350 can be prevented from performing an abnormal operation due to the violation of the power sequence.

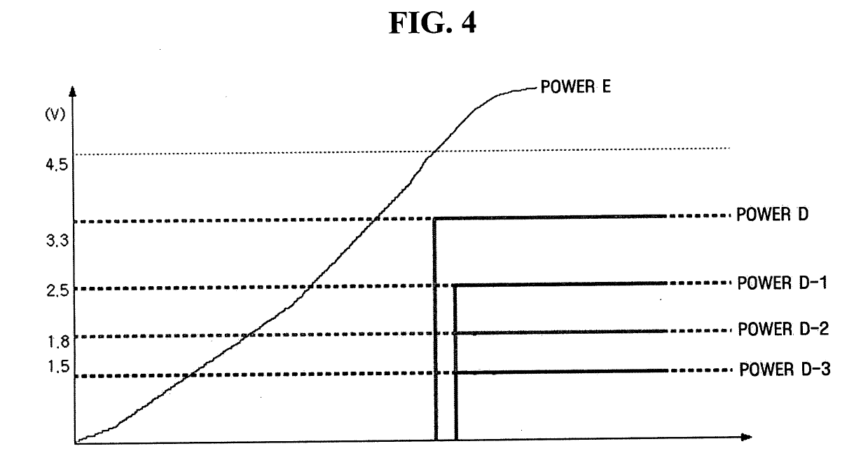

FIG. 4 is a graph illustrating time periods required for applying powers to the device 350 of FIG. 3 according to an embodiment of the present invention. FIG. 4 shows that the power D is first applied to the device_D 350, and then other powers (i.e., power D-1, power D-2 and power D-3) are substantially simultaneously applied to the device_D 350. The time periods for which the power D-1, power D-2 and power D-3 are applied to the device_D 350 may be slightly different from one another.

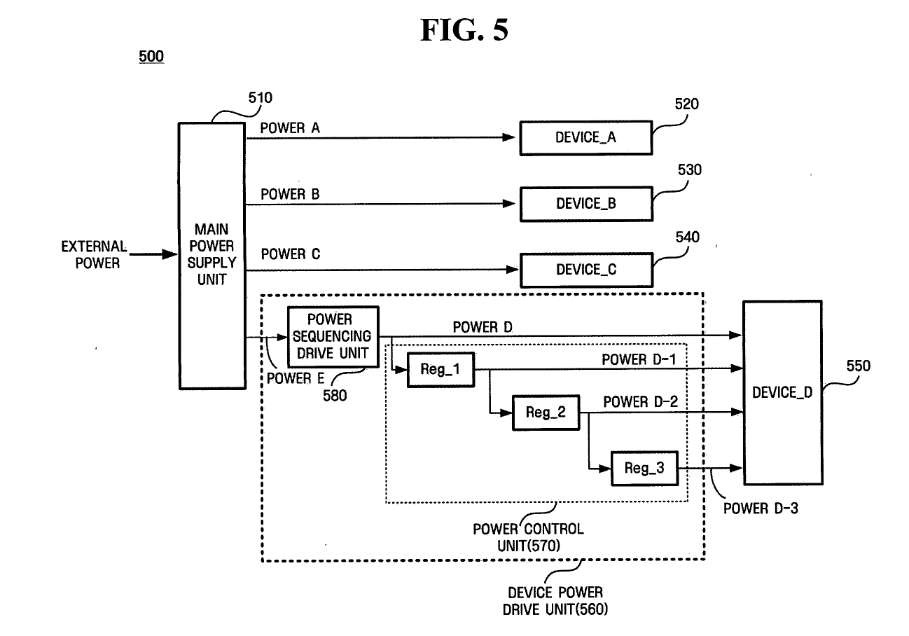

FIG. 5 is a block diagram illustrating the construction of a system 500 for performing a power sequencing according to another embodiment of the present invention.

A main power supply unit 510, device_A 520, device_B 530, device_C 540 and device_D 550 as illustrated in FIG. 5 correspond to the main power supply unit 310, device_A 320, device_B 330, device_C 340 and device_D 350 illustrated in FIG. 3, respectively. Also, a device power drive unit 560 and a power sequencing drive unit 580 as illustrated in FIG. 5 correspond to the device power drive unit 360 and the power sequencing drive unit 380 as illustrated in FIG. 3, respectively. However, a plurality of converters constituting a power control unit 570 as illustrated in FIG. 5 are constructed in a different manner than those constituting the power control unit 370 illustrated in FIG. 3.

A ‘Reg_{—}1’ converter provided in the power control unit 570 illustrated in FIG. 5 receives the power D from the power sequencing drive unit 580, and outputs the power D-1. A ‘Reg_{—}2’ converter receives the power D-1 from the ‘Reg_{—}1’ converter, and outputs the power D-2. A ‘Reg_{—}3’ converter receives the power D-2 from the ‘Reg_{—}2’ converter, and outputs the power D-3. In this circuit construction, the power D is first applied to the device_D 550, and then the power D-1, power D-2 and power D-3 are applied to the device_D 550 in order. Consequently, a time delay occurs in applying the powers to the device_D 550. If the device that operates by a plurality of powers having different levels has a power sequence in which the power having the largest level is first applied to the device and the power having the smallest level is applied to the device last, the structure of the power control unit 570 as illustrated in FIG. 5 can be used.

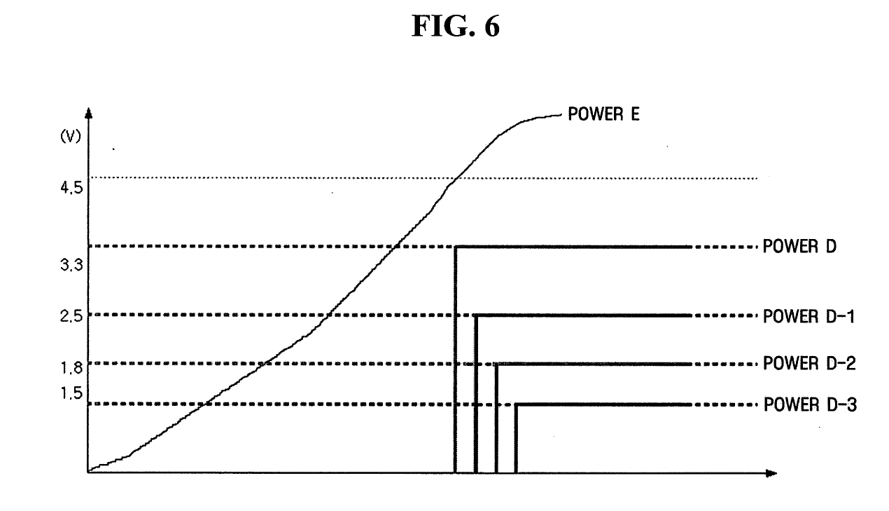

FIG. 6 is a graph illustrating time periods required for applying powers to the device according to the construction of the power control unit 570 as illustrated in FIG. 5.

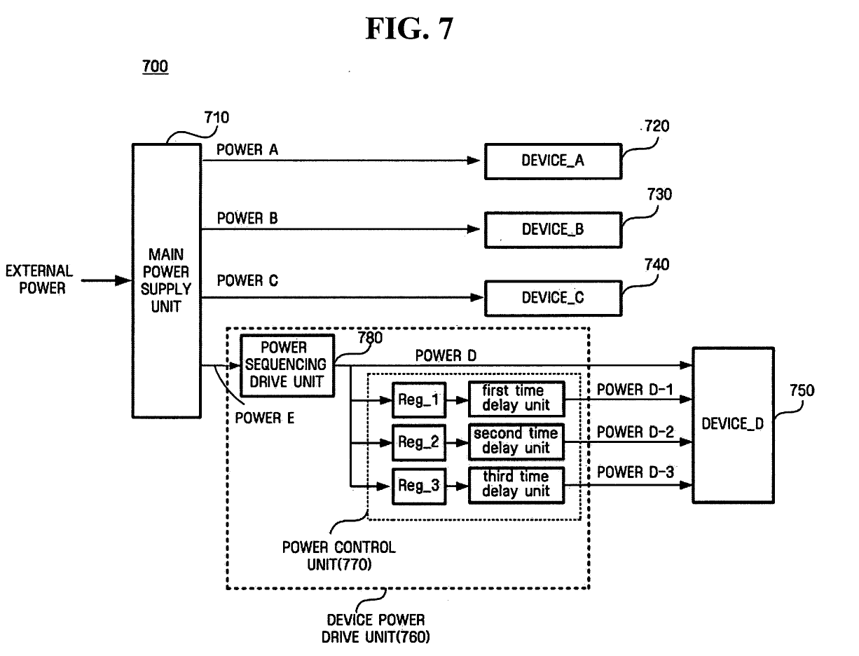

FIG. 7 is a block diagram illustrating the construction of a system for performing a power sequencing according to still another embodiment of the present invention.

A main power supply unit 710, device_A 720, device_B 730, device_C 740 and device_D 750 as illustrated in FIG. 7 correspond to the main power supply unit 310, device_A 320, device_B 330, device_C 340 and device_D 350 as illustrated in FIG. 3, respectively. Also, a device power drive unit 760 and a power sequencing drive unit 780 as illustrated in FIG. 7 correspond to the device power drive unit 360 and the power sequencing drive unit 380 as illustrated in FIG. 3, respectively. However, in this embodiment as illustrated in FIG. 7, time delay units are added to the respective converters that constitute the power control unit 370 as illustrated in FIG. 3. The time delay unit is for adjusting the time delays of the respective power supplies, and may be implemented using a circuit element for performing a time delay function. Preferably, the time delay units are located at output terminals of the respective converters that constitute the power control unit 770.

In this case, it is assumed that the levels of the powers to be applied to the device_D 750 are set as the application of power D before power D-1, power D-2, or power D-3, and the power D-1, power D-2 and power D-3 have respective time delays based on the power D so that the power D is first applied to the device and then the power D-2, power D-1 and power D-3 are applied to the device in order. Specifically, the power D-1, power D-2 and power D-3 have the time delays of T₁, T₂ and T₃ based on the power D.

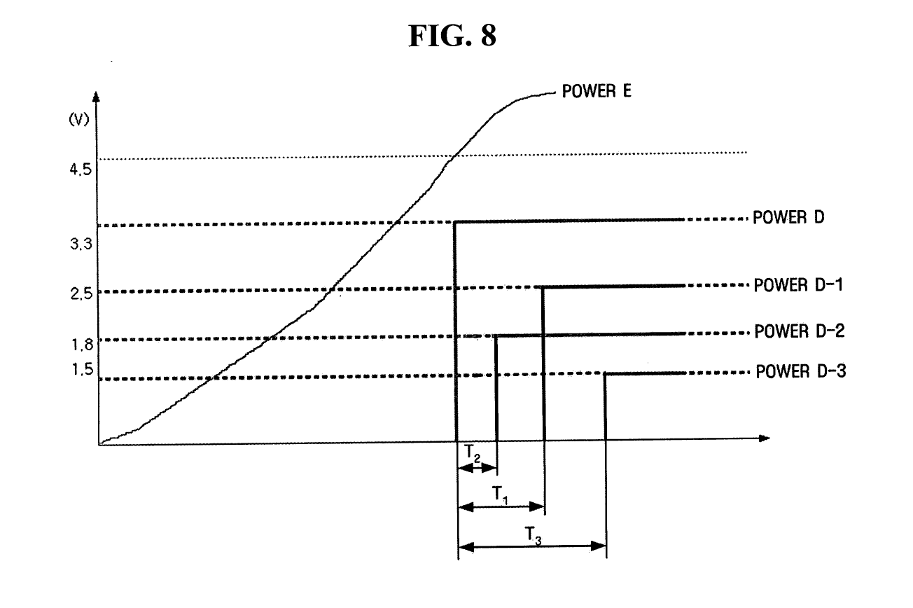

As illustrated in FIG. 7, the Reg_{—}1 converter converts the power D inputted to the power control unit 770 into the power D-1, and the power D-1 is supplied to the device_D 750 after the time delay of T₁ occurs. The power D-2 and power D-3 may be supplied to the device_D 750 in the same manner. FIG. 8 is a graph illustrating time periods required for applying powers to the device according to the embodiment as illustrated in FIG. 7.

Meanwhile, by adding the time delay units as illustrated in FIG. 7 to the power control unit 570 as illustrated in FIG. 5, a result that satisfies the power sequence of the device_D 550 may be obtained.

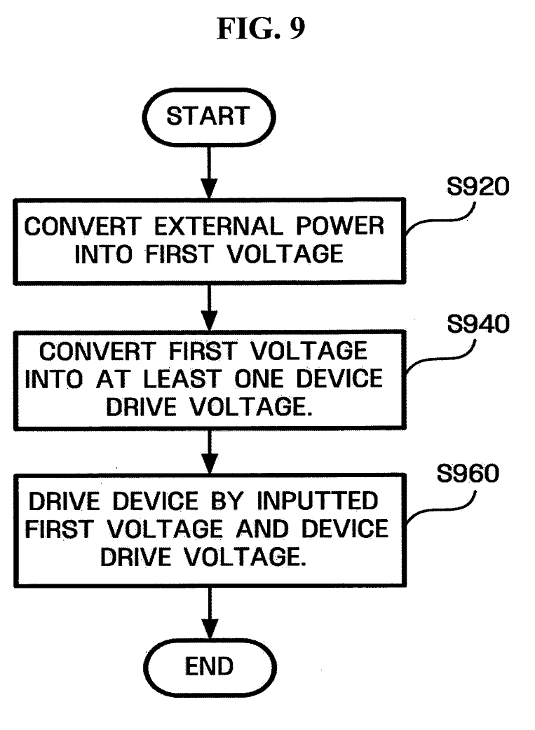

FIG. 9 is a flowchart illustrating a method for performing a power sequencing according to an embodiment of the present invention.

Referring to FIG. 9, if the external power is supplied to the system, it is converted into a first voltage for operating devices that constitute the system (step S920). Then, the first voltage is converted into at least one device drive voltage for operating the devices (step S940). The devices receive the first voltage and the device drive voltages and start to operate (step S960). In this case, the circuit for converting the first voltage into the device drive voltages may be the power control unit 370 of FIG. 3, or power control unit 570 of FIG. 5 or the power control unit 770 of FIG. 7.

As described above, the present invention can provide a circuit that satisfies the power sequence of devices operating by a plurality of powers having different levels, and thus the devices can stably operate with the product reliability improved.

Although preferred embodiments of the present invention have been described for illustrative purposes, those skilled in the art will appreciate that various modifications, additions and substitutions are possible, without departing from the scope and spirit of the invention as disclosed in the accompanying claims.

1. A system for performing a power sequencing, comprising:
a main power supply unit for receiving a power from an external power source;
a power sequencing drive unit for receiving an output voltage of the main power supply and outputting a preset first voltage;
a power control unit for receiving the first voltage and outputting at least one different device drive voltage; and
a device for receiving the first voltage and the device drive voltage and operating by the received voltages.

2. The system as claimed in claim 1, wherein the power sequencing drive unit comprises a step-down regulator IC.

3. The system as claimed in claim 1, wherein the power control unit comprises at least one DC-to-DC converter which receives the first voltage and outputs the device drive voltage.

4. The system as claimed in claim 3, wherein the power control unit comprises a plurality of DC-to-DC converters and the DC-to-DC converters receive the first voltage simultaneously.

5. The system as claimed in claim 4, wherein the power control unit further comprises a time delay unit for delaying a transfer of the device drive voltages outputted from output terminals of the DC-to-DC converters.

6. The system as claimed in claim 1, wherein the power control unit comprises:
a first DC-to-DC converter for receiving the first voltage and outputting a first device drive voltage; and
a second DC-to-DC converter for receiving the first device drive voltage and outputting a second device drive voltage;
wherein the first voltage, the first device drive voltage and the second device drive voltage are outputted to the device.

7. The system as claimed in claim 6, wherein the power control unit further comprises a time delay unit for delaying a transfer of the device drive voltages outputted from output terminals of the DC-to-DC converters.

8. The system as claimed in claim 7, wherein the time delay unit can delay the device drive voltages by different time periods.

9. The system as claimed in claim 3, wherein the DC-to-DC converter comprises a regulator IC.

10. The system as claimed in claim 1, wherein the device receives the first voltage prior to the device drive voltage, and operates accordingly.

11. The system as claimed in claim 1, wherein the device receives the first voltage and the device drive voltages in a selected order, and operates accordingly.

12. A method for performing a power sequencing, comprising the steps of:
(a) receiving a power from an external power source;
(b) converting the power into a first voltage for operating devices that constitute a system;
(c) converting the first voltage into at least one device drive voltage; and
(d) outputting the first voltage and the device drive voltage to the devices.

13. The method as claimed in claim 12, wherein the step (b) comprises the step of converting the first voltage using a step-down regulator IC.

14. The method as claimed in claim 12, wherein the step (c) converts the first voltage into at least one device drive voltage using at least one DC-to-DC converter.

15. The method as claimed in claim 14, wherein the DC-to-DC converters receive the first voltage simultaneously.

16. The method as claimed in claim 15, wherein the step (a) comprises operating a time delay unit for delaying a transfer of the device drive voltages outputted from output terminals of the DC-to-DC converters.

17. The method as claimed in claim 12, wherein the step (c) comprises the steps of:
receiving and converting the first voltage into a first device drive voltage; and
receiving and converting the first device drive voltage into a second device drive voltage; and
wherein the step (d) comprises the step of outputting the first voltage, the first device drive voltage and the second device drive voltage to the device.

18. The method as claimed in claim 17, wherein a time delay unit delays a transfer of the first and second device drive voltages outputted from output terminals of the DC-to-DC converters.

19. The method as claimed in claim 18, wherein the time delay unit delays the transfer of the first and second converters by different time periods.

20. The method as claimed in claim 14, wherein the DC-to-DC converter comprises a regulator IC.

21. The method as claimed in claim 12, further comprising the step of (e) the device receiving the first voltage prior to the device drive voltage, and operating accordingly.

22. The method as claimed in claim 12, further comprising the step of (e) the device receiving the first voltage and the device drive voltages in order, and operating accordingly.
